(19) United States
(12) Patent Application Publication
(10) Pub. No.: US 2022/0046443 A1
(43) Pub. Date: Feb. 10, 2022

(54) CHANNEL STATE INFORMATION-REFERENCE SIGNAL BASED MEASUREMENT

(71) Applicant: Apple Inc., Cupertino, CA (US)

(72) Inventors: Yang Tang, San Jose, CA (US); Silvano Gori, Marktl (DE); Herbert R. Dawid, Herzogenrath (DE); Hong He, San Jose, CA (US); Wei Zeng, Saratoga, CA (US); Weidong Yang, San Diego, CA (US); Chunxuan Ye, San Diego, CA (US); Haitong Sun, Cupertino, CA (US); Jie Cui, San Jose, CA (US); Manasa Raghavan, Sunnyvale, CA (US); Huaning Niu, San Jose, CA (US); Dawei Zhang, Saratoga, CA (US)

(73) Assignee: Apple Inc., Cupertino, CA (US)

(21) Appl. No.: 17/368,645

(22) Filed: Jul. 6, 2021

Related U.S. Application Data
(60) Provisional application No. 63/062,311, filed on Aug. 6, 2020.

(51) Int. Cl. H04W 24/08; H04L 5/00; H04W 56/00; H04W 24/10

(52) U.S. Cl. CPC H04W 24/08; H04W 24/10; H04W 56/001; H04L 5/0048

(57) ABSTRACT

The present application relates to devices and components including apparatus, systems, and methods to provide channel state information-reference signal configurations to facilitate measurements.

### CROSS REFERENCE TO RELATED APPLICATIONS

This application claims the benefit of U.S. Provisional Application No. 63/062,311, filed Aug. 6, 2020, which is hereby incorporated by reference in its entirety for all purposes.

### BACKGROUND

Third Generation Partnership Project (3GPP) defines a number of reference signals to facilitate communications in a wireless access cell. A channel state information (CSI)-reference signal (RS) is a multipurpose downlink transmission. The CSI-RS may be used for CSI reporting, beam management, connected mode mobility, radio link failure detection, beam failure detection and recovery, and fine tuning of time and frequency synchronization.

### BRIEF DESCRIPTION OF THE DRAWINGS

FIG. 1 illustrates a network environment, in accordance with some embodiments.

FIG. 2 illustrates a measurement configuration call flow, in accordance with some embodiments.

FIG. 3 illustrates a measurement object, in accordance with some embodiments.

FIG. 4 illustrates a user equipment (UE) capability call flow, in accordance with some embodiments.

FIG. 5 illustrates UE components, in accordance with some embodiments.

FIG. 6 illustrates an operational flow/algorithmic structure, in accordance with some embodiments.

FIG. 7 illustrates an operational flow/algorithmic structure, in accordance with some embodiments.

FIG. 8 illustrates a user equipment, in accordance with some embodiments.

FIG. 9 illustrates a gNB, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes one or more hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP) that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

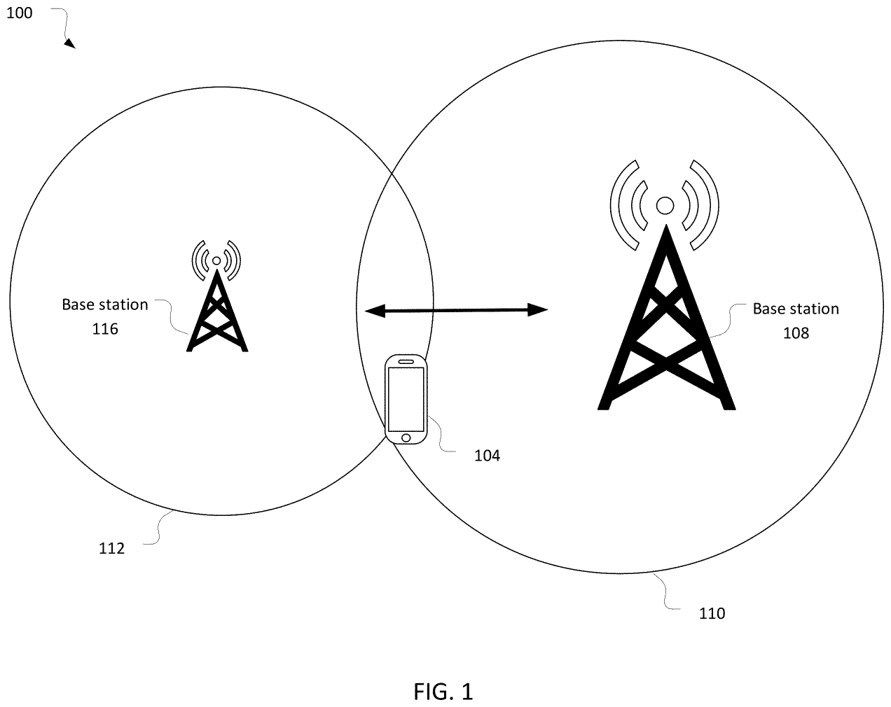

FIG. 1 illustrates a network environment 100, in accordance with some embodiments. The network environment 100 may include a UE 104 and a base station 108. The base station 108 may provide a serving cell 110 through which the UE 104 may communicate with the base station 108. In some embodiments, the base station 108 is a gNB that provides 3GPP New Radio (NR) cell. In other embodiments, the base station 108 is an eNB that provides an LTE cell. The air interface over which the UE 104 and base station 108 communicate may be compatible with 3GPP technical specifications, such as those that define Fifth Generation (5G) NR system standards.

The network environment 100 may further include a neighbor cell 112 provided by base station 116. The base station 116 may use the same radio access technology as the base station 108 or a different radio access technology.

To adapt to changes in a radio environment and relative positioning between the UE 104 and the base stations, the UE 104 may perform a variety of measurements that may be used for radio resource management (RRM).

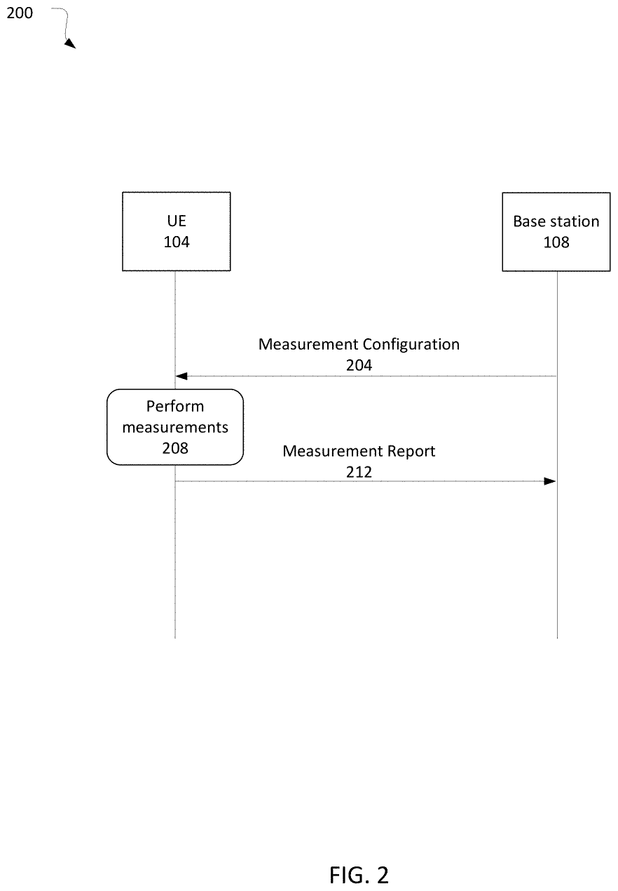

FIG. 2 illustrates a measurement configuration call flow 200, in accordance with some embodiments. The base station 108 may transmit a measurement configuration 204 to provide the UE 104 with information to perform a variety of measurements to support RRM. For example, in some embodiments, the base station 108 may configure the UE 104 to perform measurements on signals transmitted in the neighbor cell 112 provided by the base station 116. In various embodiments, the measurement configuration 204 may instruct the UE 104 to perform intra-frequency or inter-frequency measurements based on either synchronization signal and physical broadcast channel blocks (SSB) or CSI-RS resources. In both cases, the measurements may be beam-level or cell-level. SSB intra-frequency measurements may correspond to situations in which both the serving cell 110 and the neighbor cell 112 use the same SSB center frequency and subcarrier spacing. The CSI-RS intra-frequency measurements may correspond to situations in which the neighbor cell 112 is configured with a CSI-RS resource bandwidth that is confined within a bandwidth of the CSI-RS resource belonging to the serving cell 110, and both CSI-RSs use the same subcarrier spacing.

The measurement configuration may be transmitted to the UE 104 while the UE 104 is in a radio resource control (RRC)-connected mode by dedicated signaling, such as RRC signaling, for example, an RRC reconfiguration message or RRC resume message.

At 208, the UE 104 may use the measurement configuration to perform measurements and report corresponding results to the base station 108 in a measurement report 212. If the measurements are based on SSB, the report 212 may include measurement results per SSB, measurement results per cell based on SSB, and SSB indices. If the measurements are based on CSI-RS resources, the report 212 may include measurement results per CSI-RS resource; measurement results per cell based on CSI-RS resource(s), and CSI-RS resource measurement identifiers.

Results from these measurements may be used to manage mobility of the UE 104 in situations in which the neighbor cell 112 provides the UE 104 with a better signal than the serving cell 110.

In some embodiments, a measurement configuration, such as measurement configuration 204, may include a measurement identity, a measurement object, and reporting configurations. The reporting configuration may specify whether a report is periodic, event triggered, or cell global identity (CGI) reporting. The measurement identity may link a reporting configuration to a measurement object. The measurement identity may include a first pointer toward a reporting configuration and a second pointer toward a measurement object.

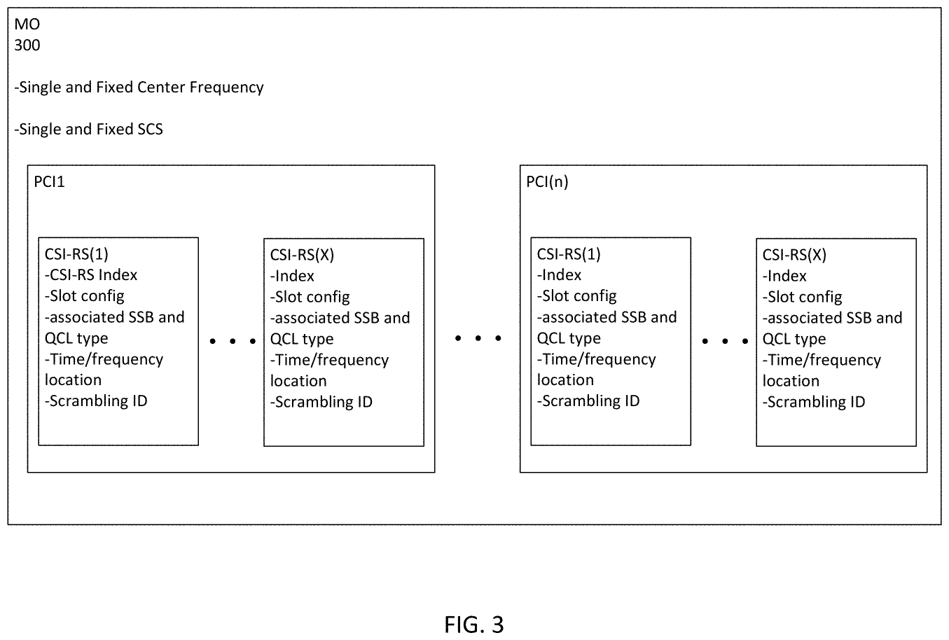

The measurement object may provide information about SSBs and CSI-RS resources that are to be measured. FIG. 3 illustrates a measurement object 300, in accordance with some embodiments. The measurement object 300 may include a single and fixed center frequency and a single and fixed subcarrier spacing (SCS).

The measurement object 300 may further include information for multiple cells with different physical cell identifiers (PCI). FIG. 3 illustrates the measurement object 300 being configured with information for n PCIs. Each PCI may be independently configured with a fixed bandwidth in terms of a number of physical resource blocks. For example, the PCIs may have bandwidths of 24, 48, 96, 192, or 264.

Each PCI may be independently configured with a fixed CSI-RS density, which may indicate the number of resource elements in an OFDM symbol that carry a CSI-RS. In some embodiments, the PCIs may be configured with a fixed CSI-RS density of 1 or 3.

Each PCI may also be configured with up to X CSI-RS resources. The value X may be up to a maximum number of CSI-RS resources for a radio resource management (RRM) object (defined by, for example, a maxNrofCSI-RS-ResourcesRRM information element (IE)).

Each of the CSI-RS resources may be independently configured with a plurality of parameters. In some embodiments, the CSI-RS may be configured by a CSI-RS-ResourceConfigMobility IE that is used to configure the CSI-RS based RRM measurements. Each CSI-RS resource may be configured with different CSI-RS indices; slot configurations; associated SSBs and QCL types; time and frequency domain locations within a slot; and scrambling identifiers.

A CSI-RS index is the index associated to the CSI-RS resource that is to be measured (and used for reporting).

A slot configuration may indicate a CSI-RS periodicity (in milliseconds) and, for each periodicity, an offset in a number of slots. The periodicities may be 4 ms, 5 ms, 10 ms, 20 ms, or 40 ms and the maximum offset values may be: 3, 4, 9, 19, or 39 slots when SCS of the CSI-RS is set to 15 kHz; 7, 9, 19, 39, or 79 slots when SCS of the CSI-RS is set to 30 kHz; 15, 19, 39, 79, or 159 when SCS of the CSI-RS is set to 60 kHz; or 31, 39, 79, 159, or 319 slots when SCS of the CSI-RS is set 120 kHz.

The associated SSB field may provide an SSB index to identify an SSB upon which the UE 104 may base a timing of the CSI-RS resource. The associated SSB field may also include a parameter to indicate whether the CSI-RS resource is quasi-co-located with the SSB. In some embodiments, the QCL type may be provided.

The time and frequency domain location within the slot may indicate the first OFDM symbol in the PRB used for CSI-RS and a frequency domain allocation within the PRB.

The scrambling identifier may provide information about the sequence generation configuration for the CSI-RS.

In some embodiments, the measurement object may also include a pointer toward a quantity configuration. The quantity configuration may specify a set of filter coefficients that may be used for Layer 3 filtering of measurements. Layer 3 measurements may be used for RRM decisions that look to a long-term view of channel conditions. For example, handover procedures should be triggered after Layer 3 filtering to reduce the risk of ping-pong between serving cells. Measurements may be filtered at Layer 3 to remove the impact of fast fading and help reduce short-term variations and results.

The quantity configuration may specify Layer 3 filtering coefficients that define a memory of the Layer 3 filtering. A large filter coefficient may correspond to a filter with a longer memory. This means that a specific measurement result may impact the output of the filter for a longer period of time (for example, the averaging window increases). Layer 3 filtering may be applied before evaluating measurement reporting events (based on comparing quality metrics of the serving cell, neighbor cell, and various thresholds) and before reporting measurements to the base station 108.

Situations may arise when CSI-RS configurations for Layer 3 measurements are in an environment with multiple numerologies. A numerology as used herein, may refer to subcarrier spacing and symbol length. With CSI-RS resources configured for the neighbor cell 112, there is possibility that the UE 104 may need to deal with more than two different numerologies in the downlink. For example, an SSB may be configured with a 15 kHz SCS, a physical downlink shared channel (PDSCH) may be configured with a 30 kHz SCS, and a CSI-RS may be configured with a 60 kHz SCS. These situations may not be supported with existing mixed-numerology UE capability. For example, UE 104 may support two mixed numerologies, but may not be capable of processing three numerologies in the downlink.

Various embodiments describe CSI-RS configurations to facilitate Layer 3 measurements.

In some embodiments, CSI-RS configurations may be restricted to prevent more than two mixed numerologies. This may be done by restricting the management object configuration such that, for CSI-RS resources and SSBs belonging to the same management object, a single numerology is to be specified and shared. With reference to the management object 200, all the CSI-RS resources, and associated SSBs, may be restricted to having the same numerology. In some embodiments, the same numerology may be the single and fixed SCS of the management object 300. This may help to prevent more than two mixed numerologies being configured for downlink reception.

In some embodiments, the mixed numerology issue may be addressed, in whole or in part, using UE capability reporting.

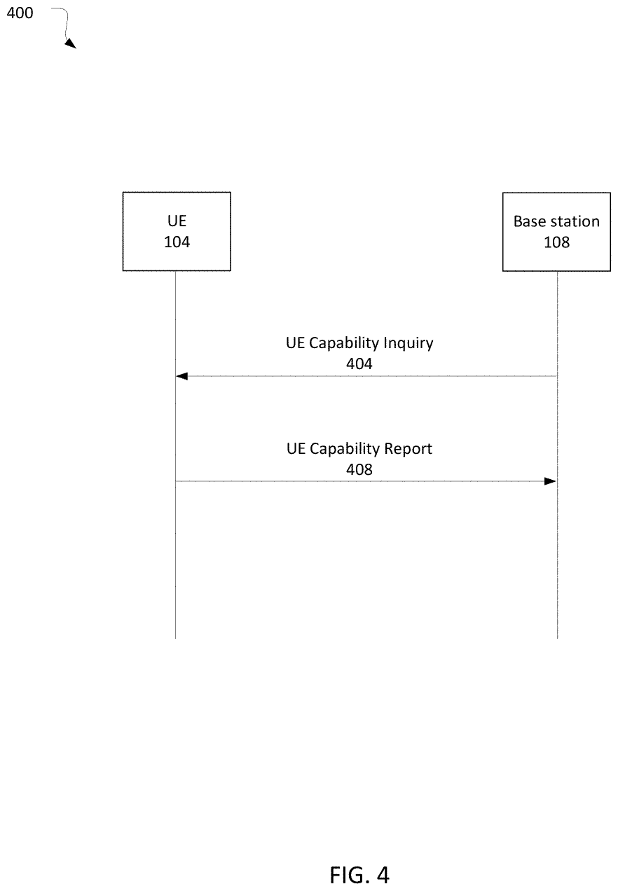

FIG. 4 illustrates a UE capability call flow 400, in accordance with some embodiments. The call flow 400 may include the base station 108 sending a UE capability inquiry 404 to the UE 104 to request capability information from the UE 104. The requested capability information may be restricted to different access technologies or operating bands of interest. The UE capability inquiry 404 may be an RRC message.

The UE 104 may respond by providing a UE capability report 408. The UE capability report 408 may be transmitted in an RRC message and may include one or more instances of a UE capability radio access technology container, with each instance applicable to a specific radio access technology. The UE capabilities indicated in the UE capability report 408 may include information related to UE support of different numerologies. For example, the UE capability report 408 may include, in a simultaneousRxDataSSB-DiffNumerology IE, an indication of whether the UE supports concurrent intra-frequency measurement on serving cell or neighbor cell and physical downlink control channel (PDCCH) or PDSCH reception from the serving cell with a different numerology. The UE capability report 408 may further include, in a simultaneousRxDataSSB-DiffNumerology-Inter-r16 IE, an indication of whether the UE supports concurrent SSB-based inter-frequency measurement without measurement gap on neighboring cell and PDCCH or PDSCH reception from the serving cell with a different numerology.

In some embodiments, additional UE capability information may be added to address the mixed numerology issue described above.

In a first example, the UE capability information may include information about simultaneous reception of data and CSI-RS with different numerologies. For example, the UE capability information may include a simultaneousRxDataCSI-RS-DiffNumerology IE to indicate whether the UE supports concurrent CSI-RS based intra-frequency measurement on serving cell or neighboring cell and PDCCH or PDSCH reception from the serving cell with a different numerology.

In a second example, the UE capability information may include information about simultaneous reception of SSB and CSI-RS with different numerologies. For example, the UE capability information may include a simultaneousRxSSBCSI-RS-DiffNumerology IE to indicate whether the UE supports concurrent CSI-RS based intra-frequency measurement on serving cell and/or neighboring cell and SSB-based measurement from the serving cell and/or intra-frequency neighboring cell with a different numerology. In this example, it may be assumed that both measured CSI resources and SSB are confined with active BWP bandwidth.

In a third example, the UE capability information may include information about simultaneous reception of data, SSB, and CSI-RS with different numerologies. For example, the UE capability information may include a simultaneousRxdataSSBCSI-RS-DiffNumerology IE to indicate whether the UE supports concurrent CSI-RS based intra-frequency measurement on serving cell and/or neighboring cell, SSB-based measurement from the serving cell and/or intra-frequency neighboring cell, and PDCCH or PDSCH reception from the serving cell with different numerologies.

The base station 108 may determine, based on one or more of these IEs, whether the UE 104 is able to handle more than two mixed numerologies.

In some embodiments, the base station 108 may configure a serving cell in a manner to avoid more than two mixed numerologies for CSI-RS resource, SSB configuration, and other non-physical broadcast channel (PBCH) DL channels per component carrier.

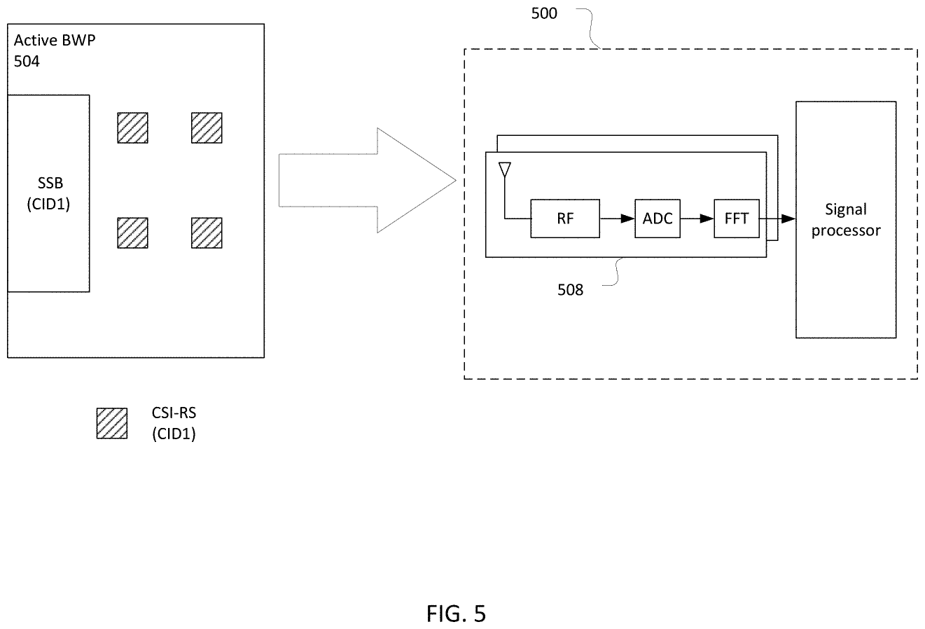

FIG. 5 illustrates components 500 of the UE 104 receiving an active bandwidth part (BWP) 504, in accordance with some embodiments.

The components may include one or more receive chains 508, each having components, such as an antenna panel, radio frequency (RF) components (for example, filters or preamplifiers), an analog-to-digital converter (ADC), and a fast Fourier transform (FFT) block. The receive chains 508 may be coupled with a signal processor which may provide additional baseband processing, such as that discussed elsewhere herein.

The active BWP 504 may include SSB and CSI-RS resources, which may both be associated with the same cell identifier (CID) and have the same numerology. Due to limited searchers and memory size, the components 500 may be challenged by performing parallel CSI-RS Layer 3 measurements and SSB measurements. Therefore, in some embodiments, UE capability reporting may be adapted to prevent parallel CSI-RS Layer 3 measurements and SSB measurements from being mandatory in scenarios in which both CSI-RS resources and SSB are within an active BWP and have the same numerology. In some embodiments, referred CSI-RS resources may be associated with serving or target cells.

To address limitations on the parallel processing, the UE capability report 408 may be adapted to include information about simultaneous reception of SSB and CSI-RS with the same numerology. For example, the UE capability information may include a simultaneousRxSSBCSI-RS-SameNumerology IE to indicate whether the UE supports concurrent CSI-RS measurement and SSB measurement with the same numerology. The referred CSI-RS and SSB could be associated with different cells including both serving cell and neighboring cells. It is however assumed that both referred CSI-RS and SSB are confined within the active BWP bandwidth.

If the UE 104 does not support parallel measurements of the SSB and CSI-RS, a sharing factor may be used to divide the measurement opportunities. In a first example, the sharing factor may indicate that the measurement opportunities are to be equally divided between the SSB and CSI-RS. In a second example, the sharing factor may indicate a CSI-RS prioritized sharing in which more measurement opportunities are used to process the CSI-RS as opposed to processing the SSB. In a third example, the sharing factor may indicate an SSB prioritized sharing in which more measurement opportunities are used to process the SSB as opposed to processing the CSI-RS.

In each of the second and third examples above, the extent of the differential in sharing the measurement opportunities may be adjusted based on various considerations. For example, in some embodiments the SSB prioritized sharing may alternate between a first split (for example, using 80% of the measurement opportunities for the SSB and 20% of the measurement opportunities for the CSI-RS) and a second split (for example, using 60% of the measurement opportunities for the SSB and 40% of the measurement opportunities for the CSI-RS).

In some embodiments, the base station 108 may determine the sharing factor to use based on UE capability report and other considerations. The base station 108 may then configure the UE 104 with the sharing factor to implement in the processing of the CSI-RS resources and the SSB. In other embodiments, the UE 104 may select the sharing factor to use on its own initiative, or select the sharing factor within constraints provided by the base station 108.

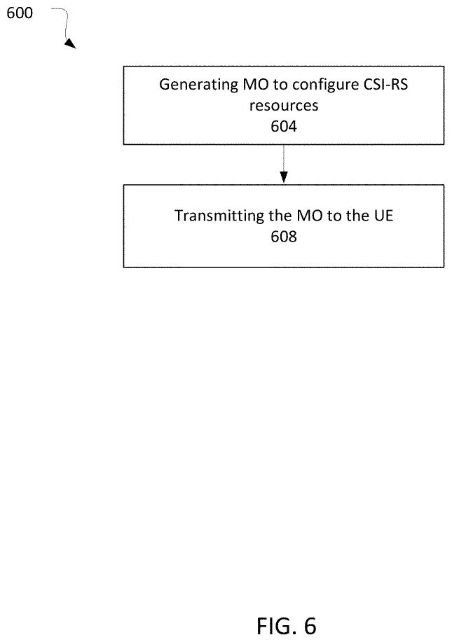

FIG. 6 may include an operation flow/algorithmic structure 600, in accordance with some embodiments. The operation flow/algorithmic structure 600 may be performed or implemented by a base station, such as base station 108 or 900; or components thereof, for example, baseband processor 904A.

The operation flow/algorithmic structure 600 may include, at 604, generating a measurement object to configure CSI-RS resources for a physical cell identity. The configured CSI-RS resources may be associated with SSBs. In some embodiments, to address situations in which a UE is unable to support more than two mixed numerologies, the measurement object may be generated in a manner such that all CSI-RS resources and associated SSBs share a common numerology.

The operation flow/algorithmic structure 600 may further include, at 608, transmitting the measurement object to a UE. In some embodiments, the measurement object may be transmitted to the UE in a measurement configuration, such as that described above with respect to FIG. 2.

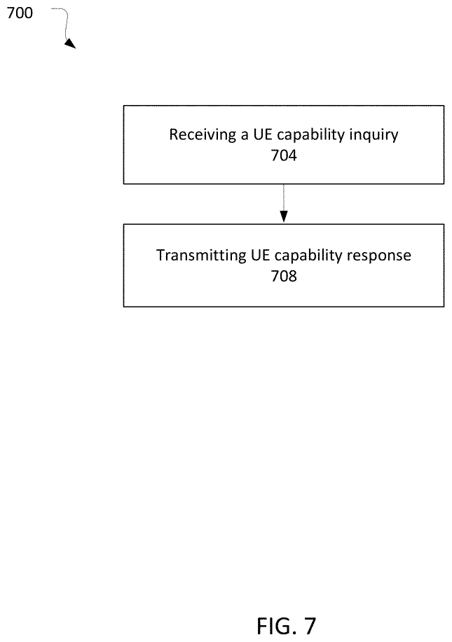

FIG. 7 may include an operation flow/algorithmic structure 700, in accordance with some embodiments. The operation flow/algorithmic structure 700 may be performed or implemented by a UE, such as UE 104 or 800; or components thereof, for example, baseband processor 804A.

The operation flow/algorithmic structure 700 may include, at 704, receiving a UE capability inquiry. The UE capability inquiry may be similar to that described above with respect to FIG. 4.

The operation flow/algorithmic structure 700 may further include, at 708, transmitting a UE capability response. In some embodiments, the UE capability response may include information about whether the UE supports concurrent reception of CSI-RS resources and SSBs with different numerologies; concurrent reception of CSI-RS resources and SSB (with same or different numerologies); or concurrent reception of CSI-RS resources, SSB, and data.

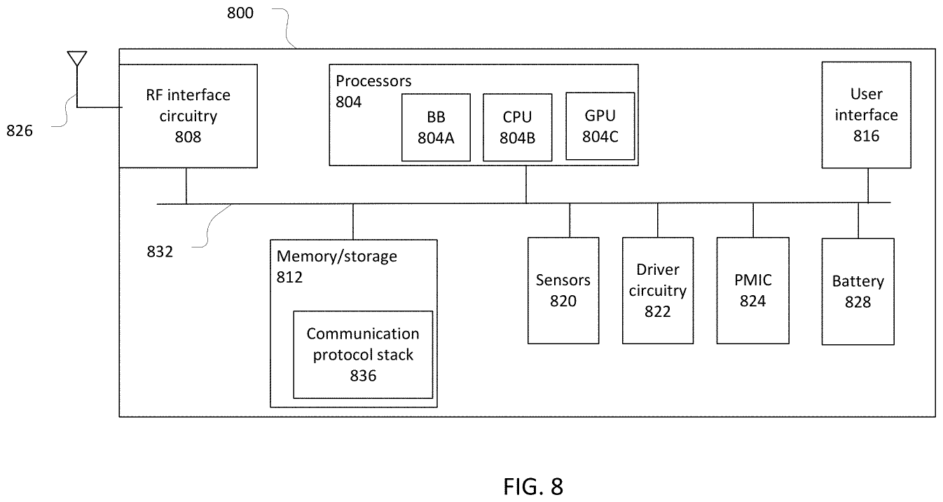

FIG. 8 illustrates a UE 800, in accordance with some embodiments. The UE 800 may be similar to and substantially interchangeable with UE 104 of FIG. 1.

The UE 800 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators) video surveillance/monitoring devices (for example, cameras, video or cameras) wearable devices; or relaxed-IoT devices. In some embodiments, the UE may be a reduced capacity UE or NR-Light UE.

The UE 800 may include processors 804, RF interface circuitry 808, memory/storage 812, user interface 816, sensors 820, driver circuitry 822, power management integrated circuit (PMIC) 824, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 832, which may represent any type of interface, input/output, bus (local, system, or expansion), transmission line, trace, or optical connection that allows various circuit components (on common or different chips or chipsets) to interact with one another.

The processors 804 may include processor circuitry, such as baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812 to cause the UE 800 to perform operations as described herein.

In some embodiments, the baseband processor circuitry 804A may access a communication protocol stack 836 in the memory/storage 812 to communicate over a 3GPP compatible network. In general, the baseband processor circuitry 804A may access the communication protocol stack to: perform user plane functions at a PHY layer, MAC layer, RLC layer, PDCP layer, service data adaptation (SDAP) layer, and protocol data unit (PDU) layer; and perform control plane functions at a PHY layer, MAC layer, RLC layer, PDCP layer, RRC layer, and a non-access stratum (NAS) layer. In some embodiments, the PHY layer operations may additionally/alternatively be performed by the components of the RF interface circuitry 808.

The baseband processor circuitry 804A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 812 may include any type of volatile or non-volatile memory that may be distributed throughout the UE 800. In some embodiments, some of the memory/storage 812 may be located on the processors 804 themselves (for example, L1 and L2 cache), while other memory/storage 812 is external to the processors 804 but accessible thereto via a memory interface. The memory/storage 812 may include any suitable volatile or non-volatile memory, such as dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 808 may include transceiver circuitry and radio frequency front module (RFEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, or control circuitry.

In the receive path, the RFEM may receive a radiated signal from an air interface via an antenna 826 and proceed to filter and amplify (with a low-noise amplifier) the signal. The signal may be provided to a receiver of the transceiver that down-converts the RF signal into a baseband signal that is provided to the baseband processor of the processors 804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 826.

In various embodiments, the RF interface circuitry 808 may be configured to transmit/receive signals in a manner compatible with NR access technologies.

The antenna 826 may include a number of antenna elements that each convert electrical signals into radio waves to travel through the air and to convert received radio waves into electrical signals. The antenna elements may be arranged into one or more antenna panels. The antenna 826 may have antenna panels that are omnidirectional, directional, or a combination thereof to enable beamforming and multiple input, multiple output communications. The antenna 826 may include microstrip antennas, printed antennas fabricated on the surface of one or more printed circuit boards, patch antennas, or phased array antennas. The antenna 826 may have one or more panels designed for specific frequency bands including bands in FR1 or FR2.

The user interface circuitry 816 includes various input/output (I/O) devices designed to enable user interaction with the UE 800. The user interface 816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs such, as display devices or touchscreens (for example, liquid crystal displays (LCDs), LED displays, quantum dot displays, or projectors), with the output of characters, graphics, multimedia objects, and the like being generated or produced from the operation of the UE 800.

The sensors 820 may include devices, modules, or subsystems whose purpose is to detect events or changes in its environment and send the information (sensor data) about the detected events to some other device, module, or subsystem. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like), depth sensors, ambient light sensors, ultrasonic transceivers; or microphones or other like audio capture devices.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various input/output (I/O) devices that may be present within, or connected to, the UE 800. For example, driver circuitry 822 may include a display driver to control and allow access to a display device, a touchscreen driver to control and allow access to a touchscreen interface, sensor drivers to obtain sensor readings of sensor circuitry 820 and control and allow access to sensor circuitry 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage power provided to various components of the UE 800. In particular, with respect to the processors 804, the PMIC 824 may control power-source selection, voltage scaling, battery charging, or DC-to-DC conversion.

In some embodiments, the PMIC 824 may control, or otherwise be part of, various power saving mechanisms of the UE 800. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 800 may power down for brief intervals of time and thus save power. If there is no data traffic activity for an extended period of time, then the UE 800 may transition off to an RRC_Idle state, where it disconnects from the network and does not perform operations such as channel quality feedback or handover. The UE 800 goes into a very low power state and it performs paging where again it periodically wakes up to listen to the network and then powers down again. The UE 800 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 828 may power the UE 800, although in some examples the UE 800 may be mounted deployed in a fixed location, and may have a power supply coupled to an electrical grid. The battery 828 may be a lithium ion battery, a metal-air battery, such as a zinc-air battery, an aluminum-air battery, a lithium-air battery, and the like. In some implementations, such as in vehicle-based applications, the battery 828 may be a typical lead-acid automotive battery.

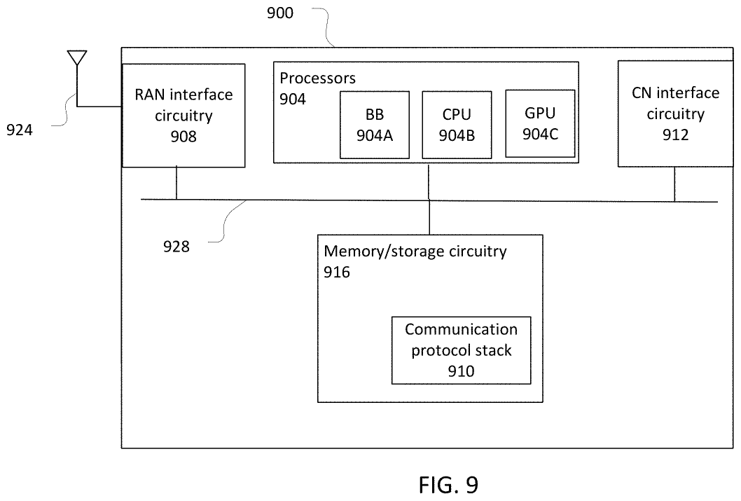

FIG. 9 illustrates a base station 900, in accordance with some embodiments. The base station 900 may similar to and substantially interchangeable with base station 108.

The base station 900 may include processors 904, RF interface circuitry 908, core network (CN) interface circuitry 912, and memory/storage circuitry 916.

The components of the base station 900 may be coupled with various other components over one or more interconnects 928.

The processors 904, RF interface circuitry 908, memory/storage circuitry 916 (including communication protocol stack 910), antenna 924, and interconnects 928 may be similar to like-named elements shown and described with respect to FIG. 8.

The CN interface circuitry 912 may provide connectivity to a core network, for example, a 5th Generation Core network (5GC) using a 5GC-compatible network interface protocol, such as carrier Ethernet protocols or some other suitable protocol. Network connectivity may be provided to/from the base station 900 via a fiber optic or wireless backhaul. The CN interface circuitry 912 may include one or more dedicated processors or FPGAs to communicate using one or more of the aforementioned protocols. In some implementations, the CN interface circuitry 912 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### Examples

In the following sections, further exemplary embodiments are provided.

Example 1 includes a method comprising: generating a measurement object (MO) to configure a plurality of channel state information-reference signal (CSI-RS) resources for a physical cell identity (PCI), wherein each CSI-RS resource of the plurality of CSI-RS resources includes a numerology and is associated with a synchronization signal and physical broadcast channel block (SSB) that includes the numerology; and transmitting the MO to a UE.

Example 2 includes the method of example 1 or some other example herein, further comprising: transmitting the MO to the UE using dedicated signaling while the UE is in an RRC connected mode.

Example 3 includes a method comprising: processing a measurement configuration from a base station, wherein the measurement configuration includes a measurement object (MO) to configure a plurality of channel state information-reference signal (CSI-RS) resources for a physical cell identity (PCI), wherein each CSI-RS resource of the plurality of CSI-RS resources includes a numerology and is associated with a synchronization signal and physical broadcast channel block (SSB) that includes the numerology; measuring one or more CSI-RSs in the plurality of CSI-RS resources; and transmitting, to the base station, results from the measuring of the one or more CSI-RSs.

Example 4 includes the method of example 3 or some other example herein, wherein a CSI-RS of the one or more CSI-RSs is transmitted in a neighbor cell.

Example 5 includes a method of operating a UE, the method comprising: receiving a UE capability inquiry from a base station; and transmitting, in response to the UE capability inquiry, a UE capability report to indicate whether the UE supports simultaneous reception of channel state information-reference signal (CSI-RS) and data or synchronization signal and physical broadcast channel block (SSB) with same or different numerologies.

Example 6 includes a method of example 5 or some other example herein, wherein the UE capability report includes an information element to indicate that the UE supports simultaneous reception of CSI-RSS and data with different numerologies.

Example 7 includes the method of example 5 or some other example herein, wherein the UE capability report includes an information element to indicate that the UE supports simultaneous reception of CSI-RSS and SSB with different numerologies.

Example 8 includes the method of example 5 or some other example herein, wherein the UE capability report includes an information element to indicate that the UE supports simultaneous reception of CSI-RSS, SSB, and data with different numerologies.

Example 9 includes the method of example 5 or some other example herein, wherein the UE capability report includes an information element to indicate that the UE supports simultaneous reception of CSI-RSS and SSB with same numerologies.

Example 10 includes a method of operating a base station, the method comprising: generating configuration information to configure a serving cell with no more than two mixed numerologies for channel state information-reference signal (CSI-RS) resource, synchronization signal and physical broadcast channel block (SSB) configuration, and other non-PBCH downlink channels per component carrier; and transmitting the configuration information to a user equipment (UE).

Example 11 includes a method of operating a base station, the method comprising: transmitting a UE capability inquiry to a user equipment; and receiving, in response to the UE capability inquiry, a UE capability report to indicate whether the UE supports simultaneous reception of channel state information-reference signal (CSI-RS) and synchronization signal and physical broadcast channel block (SSB) with same numerologies.

Example 12 includes the method of example 11 or some other example herein, wherein the UE capability report is to indicate the UE does not support simultaneous reception of CSI-RSS and SSB with same numerologies; and configuring, based on the UE capability report, the UE with a sharing factor to divide measurement opportunities between CSI-RSS and SSB.

Example 13 includes the method of example 12 or some other example herein, wherein the sharing factor is to provide an equal sharing of measurement opportunities between CSI-RS and SSB.

Example 14 includes the method of example 12 or some other example herein, wherein the sharing factor is to provide more measurement opportunities for CSI-RS than SSB.

Example 15 includes the method of example 12 or some other example herein, wherein the sharing factor is to provide more measurement opportunities for SSB than CSI-RS.

Example 16 includes a method of operating a user equipment, the method comprising: receiving a UE capability inquiry from a base station; and transmitting, in response to the UE capability inquiry, a UE capability report to indicate whether the UE supports simultaneous reception of channel state information-reference signal (CSI-RS) and synchronization signal and physical broadcast channel block (SSB) with same numerologies in an active bandwidth part.

Example 17 includes the method of example 16 or some other example herein, wherein the UE capability report is to indicate the UE does not support simultaneous reception of CSI-RSS and SSB with same numerologies; and the method further comprises determining a sharing factor to divide measurement opportunities between CSI-RSS and SSB.

Example 18 includes the method of example 17 or some other example herein, wherein the method further comprises: dividing, based on the sharing factor, a plurality of measurement opportunities equally between CSI-RS and SSB.

Example 19 includes the method of example 17 or some other example herein, wherein the method further comprise: processing, based on the sharing factor, the CSI-RS in a first share of measurement opportunities and the SSB in a second share of the measurement opportunities, wherein the first share is larger than the second share.

Example 20 includes the method of example 17 or some other example herein, wherein the method further comprise: processing, based on the sharing factor, the CSI-RS in a first share of measurement opportunities and the SSB in a second share of the measurement opportunities, wherein the first share is smaller than the second share.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. A method of operating a user equipment (UE), the method comprising:
identifying first measurement opportunities of a plurality of measurement opportunities;
identifying second measurement opportunities of the plurality of measurement opportunities, wherein the second measurement opportunities do not overlap with the first measurement opportunities;
measuring channel state information-reference signals (CSI-RSs) in the first measurement opportunities; and
measuring synchronization signal and physical broadcast channel blocks (SSBs) in the second measurement opportunities.

2. The method of claim 1, wherein the plurality of measurement opportunities are equally divided between the first measurement opportunities and the second measurement opportunities.

3. The method of claim 1, further comprising:
receiving a UE capability inquiry from a base station; and
transmitting, in response to the UE capability inquiry, a UE capability report to indicate that the UE does not support simultaneous reception of CSI-RSs and SSBs with same numerologies in an active bandwidth part.

4. The method of claim 1, further comprising:
determining a sharing factor to divide the plurality of measurement opportunities between the first measurement opportunities and the second measurement opportunities.

5. The method of claim 4, wherein the first measurement opportunities includes more measurement opportunities than the second measurement opportunities.

6. The method of claim 1, wherein measuring the CSI-RSs further comprises:
measuring a first CSI-RS received from a neighbor cell.

7. One or more non-transitory, computer-readable media (NTCRM) having instructions that, when executed, cause a base station to:
transmit a capability inquiry to a user equipment (UE); and
receive, in response to the capability inquiry, a capability report to indicate whether the UE supports simultaneous reception of channel state information-reference signal (CSI-RS) and synchronization signal and physical broadcast channel block (SSB).

8. The NTCRM of claim 7, wherein the capability report is to indicate the UE does not support simultaneous reception of CSI-RS and SSB with same numerologies; and configuring, based on the capability report, the UE with a sharing factor to divide measurement opportunities between CSI-RS and SSB.

9. The NTCRM of claim 8, wherein the sharing factor is to provide an equal sharing of measurement opportunities between CSI-RS and SSB.

10. The NTCRM of claim 8, wherein the sharing factor is to provide an unequal sharing of measurement opportunities between CSI-RS and SSB.

11. The NTCRM of claim 7, wherein the capability report includes an information element with information related to UE support of different numerologies.

12. The NTCRM of claim 11, wherein the UE is connected with a network through a serving cell and the information is to indicate whether the UE supports concurrent intra-frequency measurement on the serving cell or a neighbor cell and physical downlink control channel or physical downlink shared channel reception from the serving cell with a different numerology.

13. The NTCRM of claim 11, wherein the information is to indicate whether the UE supports concurrent SSB-based inter-frequency measurement without measurement gap on neighbor cell and physical downlink control channel or physical downlink shared channel reception from a serving cell with a different numerology.

14. The NTCRM of claim 11, wherein the UE is connected with a network through a serving cell and the information is to indicate whether the UE supports concurrent CSI-RS based intra-frequency measurement on the serving cell or a neighbor cell and physical downlink control channel or physical downlink shared channel reception from the serving cell with a different numerology.

15. The NTCRM of claim 11, wherein the UE is connected with a network through a serving cell and the information is to indicate whether the UE supports concurrent CSI-RS based intra-frequency measurement on the serving cell or a neighbor cell and SSB-based measurement from the serving cell or an intra-frequency neighbor cell with a different numerology.

16. The NTCRM of claim 11, wherein the UE is connected with a network through a serving cell and the information is to indicate whether the UE supports concurrent CSI-RS based intra-frequency measurement on the serving cell or a neighbor cell, SSB-based measurement from the serving cell or an intra-frequency neighbor cell, and physical downlink control channel or physical downlink shared channel reception from the serving cell with a different numerologies.

17. An apparatus comprising:
memory having instructions; and
processing circuitry coupled with the memory, the processing circuitry to execute the instructions to:
generate a measurement object (MO) to configure a plurality of channel state information-reference signal (CSI-RS) resources for a physical cell identity (PCI), wherein each CSI-RS resource of the plurality of CSI-RS resources includes a numerology and is associated with a synchronization signal and physical broadcast channel block (SSB) that includes the numerology; and
transmit the MO to a user equipment (UE).

18. The apparatus of claim 17, wherein the processing circuitry is to transmit the MO to the UE using dedicated signaling while the UE is in a radio resource control (RRC) connected mode.

19. The apparatus of claim 17, wherein the numerology comprises a subcarrier spacing and symbol length.

20. The apparatus of claim 17, wherein the processing circuitry is further to:
transmit a capability inquiry to the UE; and
receive, in response to the capability inquiry, a capability report to indicate whether the UE supports simultaneous reception of CSI-RS and SSB.
